(19) United States
(12) Patent Application Publication
(10) Pub. No.: US 2006/0085222 A1
(43) Pub. Date: Apr. 20, 2006

(54) Healthcare administration transaction method and system for the same

(76) Inventors: Paul Huang, Pasadena, CA (US); Thomas Yeh, Diamond Bar, CA (US)

Correspondence Address: WILSON SONSINI GOODRICH & ROSATI, 650 PAGE MILL ROAD, PALO ALTO, CA, 94304-1050, US

(21) Appl. No.: 10/965,406

(22) Filed: Oct. 14, 2004

(51) Int. Cl. G06Q 50/00

(52) U.S. Cl. 705/2; 705/4

(57) ABSTRACT

A system for automated processing of encounter and billing data while in a roaming environment, comprising a static system that creates appointment and encounter slots, and reserves a space for data from a missing patient encounter, and a wireless system that includes (1) a handheld device that receives and displays reminders and encounter slot number information; and (2) a handheld device that captures and transmits encounter data to the static system, wherein the static system and the wireless system substantially decrease administrative manual transaction data processing is disclosed. A healthcare transaction method is also disclosed.

### FIELD OF THE INVENTION

The present invention generally relates to a healthcare transaction method and system. The present invention more particularly relates to a healthcare transaction method and system that provide efficient patient administration and revenue collection for physicians and related provider entities.

### BACKGROUND OF THE INVENTION

Physicians, other ancillary service providers (e.g., pharmacies, laboratories, outpatient centers, diagnostic facilities) and payers constitute a huge, uncoordinated matrix that functions mostly on a local or regional level. The delivery of medical care to patients within this matrix has become more and more difficult and costly. Some of the factors affecting healthcare providers include: reductions in fee schedules; increasing demand for documentation of what is performed; the need to practice more defensively due to the litigious nature of the medical environment; increasing consumerism and more demanding and older, sicker patients; voluminous amounts of paperwork and procedures from various payer organizations; higher office operating and overhead costs; significant time delays between filing claims for services provided and payment received, and even longer for initially rejected claims; increased surveillance by the government with respect to fraud and abuse issues; and more hours of work, seeing more patients for less income. These factors have increased the number of claims and cost of healthcare administration, as have the following: continuing development of new medical technology; aging of the population; extension of healthcare insurance coverage to more people; increasing incidence of fraud and abuse; and the increased cost of medical compliance.

The healthcare transaction cost factor as outlined in the June 1999 “Health Web Watch” study by Punk, Ziegel and Company exceeds $300 billion annually. The Health Web Watch study estimates that over 50% of this cost could be eliminated through the adoption of Internet based solutions for healthcare transactions. Given the American Medical Association's (AMA) estimate of $54 billion in claims processing cost alone, a potential savings of $27 billion or $4.22 per claim is thus attainable. Additionally, the Health Web Watch study estimates that inefficient access to clinical information costs the healthcare industry hundreds of millions of dollars annually in sub-optimal, under and over treatment.

The cost of claims preparation, claims examination, call center support, fraud and abuse and overhead associated with systems and personnel to execute these activities is a cost borne by payers and does not even consider the provider-based costs associated with the process. The ever-increasing administrative costs of this large market are driven by the growth of healthcare services coupled with the inefficiencies in delivery and low productivity that result from non-communicating legacy systems. The particular demand for large volumes of paperwork, double entry of data, and the need for human voice communication to accomplish even basic business and financial transactions has become a crisis. Many competitors lack product focus or languish with product design problems.

There have been many attempts to control actual medical costs and their associated administrative costs. These attempts have been largely unsuccessful due to the absolute increase in the volume of care, complexity of new devices, drastic change in inputs, advancing medical technology, the aging of the population, the significant amount of fraud and abuse, and the increasingly stringent regulation by both payers and oversight agencies (including state and federal governments). As indicted in the related art, current attempts to solve this problem focus on use of the PC to electronically file claims, usually during a daily batch transmission to a claims clearing house, which then forwards the claim to the appropriate payer. After that, all disputes and issues relating to a claim and its status become the responsibility of the provider.

With specific regard to individual claim submissions, for example, payers, who generate the terms by which payment will be made, can deny or review a particular claim for a variety of reasons. Missing patient information, data entry error, double billing, unbundling of medical procedures, excessive treatments deemed not medically necessary, incorrect diagnosis (“ICD”) codes, incomplete (e.g., unmodified) treatment (“CPT”) codes, uninsured or otherwise ineligible patients, lack of authorization or referral, wrong provider identification number, and numerous other problems exist. Any of these problems will slow processing and thus payment, or worse. Incorrect CPT codes significantly reduce reimbursement amounts—with a physician having no idea that he could have received more money. Worse yet, treatment of an ineligible (e.g., uninsured/uncovered and indigent) patient results in the involuntary imposition of a complete loss of revenues to the physician. As seen, an additional problem with current medical billing techniques is that they often cause physicians to be short-changed.

The aggregate of these individual losses, when coupled with the inefficiency and complexity of current business processes, results in larger systemic consequences. Current medical business transaction methods reduce revenues and disrupt effective management of physician practice groups, by individual physicians and other provider entities, including healthcare management organizations (“HMOs”), payers, physician contracting organizations (“PCOs”), independent physician associations (“IPAs”), and managed service organizations (“MSOs”).

Among such organizations, moreover, a large source of lost revenue are inflexible data capturing and transmission methods, especially when a healthcare professional is delivering care outside of his or her practice. For example, healthcare professionals are often ill-equipped to adequately capture and submit encounter and clinical data when they are visiting a nursing home, hospital, or patient home since have only paper and pen or awkward handheld electronic devices.

Hence, there is a need in the current art for an efficient, accurate, and timely facilitation of electronic claim payment, preferably using the Internet. Such a system should have a significantly positive impact on the cost and operational aspects of the financial and administrative side of healthcare delivery for both providers and payers. Such system must also create future efficiencies based on newly created connectivity and integrated data. For example, there is a need for pre-adjudicated claims, so that claims are submitted correctly the first time. There is also a need for provider encounter data creation, gathering, and processing to be as quick and efficient as possible.

In the context of medical billing and physician practice management, then, several systems have been developed and employed with some degree of success. United States patent application no. 2003/0069760, for example, discloses a system and method for processing and pre-adjudicating patient benefit claims that uses a rules-based process. Among other things, however, it does not provide real-time interconnection between payers and providers prior to claim submission, improve the cumbersome or technologically awkward task of physician practice data entry, provide payers and/or third parties a revenue-generating financial incentive to provide real-time connection to the system, or provide a convenient data entry format for mobile care providers.

Hence, the prior art fails to provide a healthcare transaction system that seamlessly interconnects providers to provider systems, payers and third party sponsors for the automated and efficient handling of most aspects of patient administration, wherever the patient and provider may be.

### SUMMARY OF THE INVENTION

Thus, the present invention is directed to a healthcare transaction method and system that interconnect providers to other healthcare entities for automatic and efficient handling of most aspects of patient administration, wherever the patient and provider may be.

The present invention is also directed to a healthcare transaction method and system that integrates the creation, gathering, centralization, and processing of encounter and billing data no matter where, or in what context, care is provided.

One aspect of the present invention is directed to a healthcare transaction method comprising the steps of providing a healthcare worker user access to a remote central server through a user interface, and providing a payer connection to the server or an associated server; and receiving information from the healthcare worker through the user interface; wherein the user interface comprises a handheld device that receives data directly from the healthcare worker, and wirelessly transmits it to a wireless telecommunications network that is connected to the remote central server.

In another aspect the user interface comprises a radio frequency transmitter that receives manually-input data directly from the healthcare worker, and wirelessly transmits it to a handheld transceiver connected to a wireless network that is connected to the remote central server.

In another aspect the transmitter is a pen and the transceiver is a mobile phone.

In another aspect the handheld device is a pen that applies marking indicia as it receives data.

In another aspect the handheld device receives data by reading a first pattern that has distinct sections.

In another aspect the first pattern is optically, magnetically, electro-statically, radioactively, or thermally readable.

In another aspect over, under, co-extensive, or adjacent to the pattern is placed user-readable indicia that distinguish to the user, the sections of the first pattern from one another.

In another aspect each of the sections is associated with an action. In another aspect the action is identifying an encounter, indicating an encounter slot, queuing a request to bill for a particular service, ordering a product, canceling an incorrect billing request, or transmitting data to the central server.

In another aspect previously stored action data is transmitted by marking a section of the pattern.

In another aspect the action data is transmitted from a pen to a mobile phone to the central server.

In another aspect the pattern and the user readable indicia are printed onto paper that is marked by the user with a marking indicium to initiate the action.

In another aspect the pattern is read by a laser light having a range of wavelength.

In another aspect the user readable indicia has low absorption of the wavelength range of the laser light.

In another aspect the marking indicium has a low absorption of the wavelength range of the laser light.

In another aspect an incorrectly selected action is correctable by un-selecting the action.

In another aspect un-selecting the action can automatically occur before or after data is transmitted to the central server.

In another aspect the action can be selected and un-selected as many times as the user wants.

In another aspect the handheld device is a pen that applies marking indicium as it receives data.

In another aspect the pen transmits data to a telecommunications-to-server gateway that is in communication with the remote central server.

In another aspect the handheld device applies marking indicia to one or more of the sections.

In another aspect the central server or an associated server automatically corrects an omitted indicium marking.

In another aspect the central server, an associated server, or a person interprets an indicium marking that exists in two or more adjacent sections as designating a single action.

In another aspect the indicium marking is a check mark.

In another aspect the central server sends the user an appointment reminder.

In another aspect the central server sends the user an available encounter slot indication.

In another aspect the slot number is used to associate a hardcopy encounter record with a set of encounter data.

In another aspect the handheld device records relative positioning data as it is moved by the user.

In another aspect the handheld device moves in concert with a surgical instrument.

In another aspect the handheld device moves in concert with a writing instrument.

Another aspect of the invention is directed to a healthcare transaction system comprising: A healthcare transaction method, comprising: providing a healthcare worker access to a remote central server through at least one user interface, and providing at least one payer connection to the server; receiving information from the healthcare worker through the at least one user interface; and providing the healthcare worker automated claim handling and claim submission to the at least one payer, based on regularly updated rules; wherein the at least one user interface comprises a handheld device that receives data directly from the healthcare professional, and wirelessly transmits it to a wireless telecommunications network that is connected to the remote central server.

In another aspect the handheld device a pen that applies marking indicia as it receives data.

In another aspect the pen transmits data to a telecommunications-to-server gateway that is in communication with the remote central server.

Another aspect of the invention is directed to a healthcare transaction system, comprising a user interface that provides a healthcare worker user access to a remote central server, which receives encounter data from the healthcare worker through the interface; and an electronic data connection between the central server or an associated server and a payer, through which the server automatically bills the payer; wherein the user interface comprises a handheld device that receives the encounter data directly from the healthcare worker, and wirelessly transmits it to a wireless telecommunications network that is connected to the remote central server.

In another aspect the central server or an associated server automatically interprets an indicium marking that exists in two or more adjacent sections as designating a single action.

Another aspect of the invention is directed to a system for automated processing of encounter and billing data while in a roaming environment, comprising a static system that creates appointment and encounter slots, and reserves a space for data from a missing patient encounter, and a wireless system that includes, a handheld device that receives and displays reminders and encounter slot number information; and a handheld device that captures and transmits encounter data to the static system, wherein the static system and the wireless system substantially decrease administrative manual transaction data processing.

In another aspect the handheld device creates, gathers, stores, and transfers encounter or billing data.

In another aspect the static and wireless systems reduces potential fraud by restricting prescription requests to an attending physician or other healthcare worker.

### BRIEF DESCRIPTION OF THE DRAWINGS

In the accompanying drawings, which form a part of the specification and are to be read in conjunction therewith, and in which like reference numerals are used to indicate like parts in the various views:

FIG. 1 is a side view of a digital pen and a top view of paper used in one embodiment of the present invention;

FIG. 2 is a plan cross-sectional view along the longitudinal axis of the pen of FIG. 1, a side view of a pen cap, and a top perspective view of an associated recharging cradle according to the present invention;

FIG. 3 is a diagram of several components and communication pathways of a wireless and static system according to the present invention;

FIG. 4 is an diagram of several components and work flows of one embodiment of a method using the wireless and static systems of FIG. 3;

FIG. 5 is a flowchart of another embodiment of the method of FIG. 4;

FIG. 6 is a form used in the method of FIG. 5; and

FIG. 7 is form used in another embodiment of the method according to the present invention.

### DETAILED DESCRIPTION OF THE INVENTION

As illustrated in the accompanying drawings and discussed in detail below, one aspect of the present invention is directed to a healthcare transaction method that automates the financial transactions and administrative processes associated with patient care. This aspect provides a system that automates the collection and transmission of key reimbursement transaction and encounter data quickly and efficiently, between mobile healthcare providers and any one of the following: provider record-keeping systems, payers, pharmacies, pharmaceutical or device companies, and third-party advertisers. It integrates the creation, gathering, centralization, and processing of such data, in many cases almost instantaneously. It further creates dual soft and hard copy records and reduces the incidence of fraud such as the forging of prescriptions.

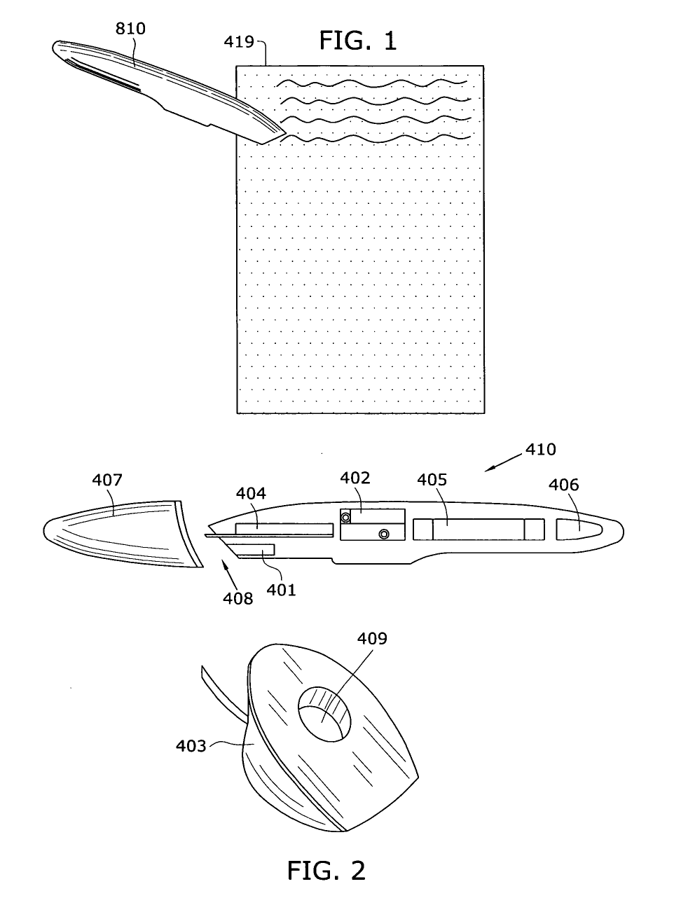

In one embodiment this aspect comprise a wireless system and a static system. The wireless system uses a digital pen to create, collect and transmit data. Referring to FIG. 1, “digital” paper 419 and digital pen 810 are used to create and receive data entry from the user as the user writes ink onto paper 419.

Referring to FIG. 2, pen 810 includes optical sensor 401 that digitally captures whatever the user writes by reading a section of a pre-printed pattern on paper 419. Processor 402 digitizes the optical signal into data that is transferred to a Bluetooth®-enabled mobile device, which transfers and receives data from a GSM telecommunications network. (CDMA or TDMA wireless networks can be used as well.). Such data is personally identifiable to a particular pen 810 or user (e.g., when a personal key identifier (PKI)) is used. Data are also individually time stamped at their creation. Pen 810 is recharged (and in an alternate embodiment, uploads data) when data transmission port 408 is placed into connection port 409 on recharging cradle 403. Replaceable ink cartridge 404 provides ink for writing that permanently adheres to paper 419, just as a normal pen does. Memory chip 405 stores up to 40 pages 419 of data, and battery 406 lasts for the collection of up to 25 pages of data between recharges at cradle 403. Cap 407 turns pen 410 off when placed on pen 810, and on when taken off pen 810.

One suitable set of paper and pen for the simultaneous creation of hard copy data and the electronic recording and communication of such data is the iScribe Digital Form and the Logitech® io™ Digital Pen available from Logitech, Inc. and respectively described in, inter alia, U.S. Pat. Nos. 6,689,966, 6,719,470, and 6,698,660, which are hereby incorporated by reference in their entireties. Similarly acceptable pens are obtainable from Nokia®, Inc.

In an alternate embodiment another pen, which does not use paper but is nevertheless suitable for use in the present invention is the VPen developed by the VIP Data Pen Consortium, which includes Decuma, Inc. of Sweden, Phillips Electronics, Inc., and Sanyo Component Europe. For example, in one embodiment the VIP Data Pen is adapted to move in concert with a surgical instrument to gather and transmit data to central server 500 regarding the trajectory and positioning of the instrument. As a result, an automatic medical record from the procedure is created, gathered, and then transmitted (e.g., using Bluetooth® or similar technology). This process in turn produces better medical notes and records by capturing exact data, which allows the caregiver to review very accurate information about the procedure and reduce the required data entry and voice dictation time for every operation. Also, the resulting better and more accurate medical records and data reduce medical liability for healthcare providers, payers, and the hospitals. As with a digital pen and paper, this pen overcomes the awkwardness that new technology often presents. Two and one half million medical personal are slow to adopt new solutions if it means adjusting their traditional behavior to accommodate unfamiliar tools and having to invest in expensive technologies. For example, PDAs present small screens, which are unusable compared to clip charts; PC keyboards are slower than more cumbersome than scribbling; and tablet PCs are bulky, have too short a battery life, and require high upfront investment. By contrast, the pens of the present aspect of the invention provide easy-to-use immediate automated data creation, gathering, and transfer of data.

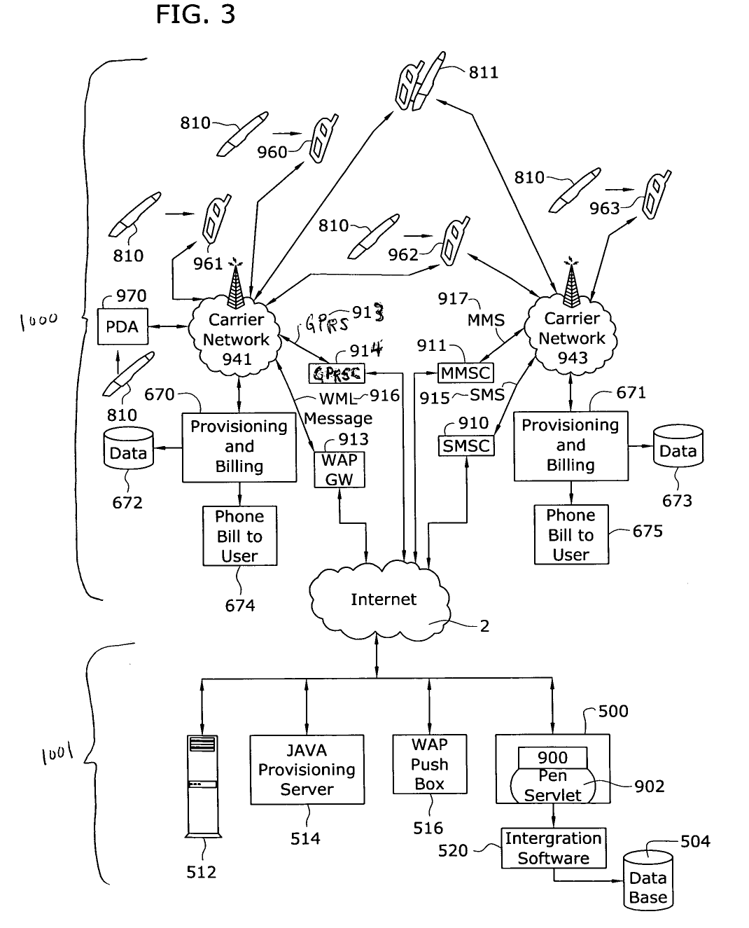

Referring to FIG. 3, in wireless system 1000 digital pen 810 is used with paper 419 to complete a hardcopy superbill, prescription, and patient chart form 420, the information from which is digitally stored in pen 810, and sent as inbound data to remote central server 500 using a wireless wide area telecommunications network. Using a Bluetooth®-enabled transmission device in pen 810, data comprising completed form 420 is sent to mobile phone 960 and then, via mobile telephone frequencies using GSM mobile telecommunications technical standards, through wireless mobile networks 941 and 943.

Bi-directional general packet ratio service (GPRS) messages 913, short messages (SMS) 915 and multimedia messages (MMS) 917 are used to send data on GSM, CDMA (not typically for GPRS), or TDMA carrier networks 941 and 943. Using these protocols, data are sent to and from mobile devices, including for example, traditional cell phone 960, i-mode phone 961, 2ME phone 962, BREW phone 963, integrated digital pen and cell phone 811 or PDA 970. Short message service (also SMS) is a bi-directional service for receiving short alphanumeric (up to 160 bytes or more) messages. SMS is also used in a cell-broadcast mode, for sending text messages. Multimedia message service (also MMS) is a bi-directional service for graphics, sound, and other multimedia files such as saved graphic view (SGV) files. Both types of messages are transported in a store-and-forward fashion. GPRS message are a packet switching overlay on a circuit switching network that supplements the other services. All types of messages are stored in a subscriber identification module (SIM) card within pen 810, pen/phone 811, PDA 970 or phones 960, 961, 962, 963 for later retrieval or transmission. For point-to-point GPRS 913, SMS 915 and MMS 917, a message is sent to another subscriber to the service, and an acknowledgement of receipt is provided to the sender.

In-bound data are sent in one embodiment from GSP network 941 through GPRS service computer 914 to internet 2. Any suitable GSP gateway software can be used.

In two other embodiments, respective in-bound SMS 915 and MMS 917 data are sent through respective short message service computers (SMSC) 910 and multimedia message service computers (MMSC) 911 to SMS/MMS gateway software 900 in remote central server 500. Wireless device generated SMS 915 and MMS 917 are thereby collected by respective SMSCs 910 and MMSCs 911, and forwarded to central server 500. Gateway software 900 handles outbound communication between central server 500 application and SMSCs 910 or MMSCs 911 as well. SMS 915 and MMS 917 generated by central server 500 are sent to wireless devices by gateway software 900 via respective SMSCs 910 and MMSCs 911. This user interface obviates the need for any personal computer connection to server 500 by the user.

Various data types are suitable for this embodiment of the invention, however. For example, text SMS can be automatically translated into the appropriate 7-Bit GSM alphabet representation, or 7-Bit coding can directly be inserted using Unicode representation. One suitable telecommunications standard is “smart messaging” offered by Nokia®, used in conjunction with Nokia® enabled devices (e.g., with hardware modem and serial interface 6210, 7110, etc., and others) that use Bluetooth® specification 1.1 wireless technology to receive data from pen 810.

One suitable SMS/MMS gateway software is available from OpenIT, GmbH of Dusseldorf, Germany. As a result, bi-directional transmission of HTTP, E-mail, Web, and scripts interfaced communications, among others, are possible—are sent and received using “smsd” Unix system daemons to interface gateway software 900 to SMSCs 910. Using this software, the following protocols, and others, can be used to communicate with SMSCs 910: ERMES UCP (Universal Computer Protocol) including Large Account related extensions, SMPP (Short Message Peer to Peer Protocol), and OIS 0 SMS2000 Open Interface Specification. The following protocols, and others, can be provided to address SMSCs 910 over the following exemplary physical links as well: TCP/IP over Internet, leased lines, DialIn, X.25, X.31, TCP/IP over X.25, and frame relay.

In another embodiment, wireless application protocol gateway 913 receives wireless mark-up language (WML) messages 916 from carrier 941. Any compatible carrier, wireless protocol, technical and language, or combinations thereof, that transfers data that can be converted, transmitted and interpreted by an application service provider system or other WAN system is suitable for the present invention, however.

Any user interface suitable for transmitting data making up form 420 directly over wireless telecommunications frequencies to a WAN wireless device-to-computer server gateway can be used in this invention. These gateway protocols include, but are not limited to, GPRS, SMS, MMS (multimedia version of SMS) WAP and WAP-push, J2ME (used in Japan), i-Mode (A compact version of HTML used by DoCoMo® and ATT® wireless), BREW (Qualcomm's® answer to J2ME, popular in Korea and China. Verizon® also supports BREW)

A wireless gateway on a telecommunication carriers' network thereby enables receipt of data to and from devices such as digital pen 810. This allows data to go to and from application server 500, thereby allowing users to seamlessly receive and transmit healthcare data from wherever they are—whether it be at a hospital, a nursing home, a private home, or anywhere within system 1000's reach.

Carrier networks 941 and 943 respectively provide wireless provisioning service and bill 670, 671 individual provider user accounts. Bills 674 and 675 are respectively sent while call data is stored in databases 672 and 673.

Static system 1001 comprises security server 512 (which acts first to check for access rights, e.g., of PKI-based or known pen ID embodiments), JAVA provisioning server 514, wireless application protocol (WAP) push box 516, and remote central server 500, which has SMS/MMS gateway software 900 and application service handler pen servlet 902. Also included are integration software 520 (such as IBM's® WebSphere® software and application integration service) and encounter database 504, which is readily accessible by server 500, associated servers, and their respective component software applications.

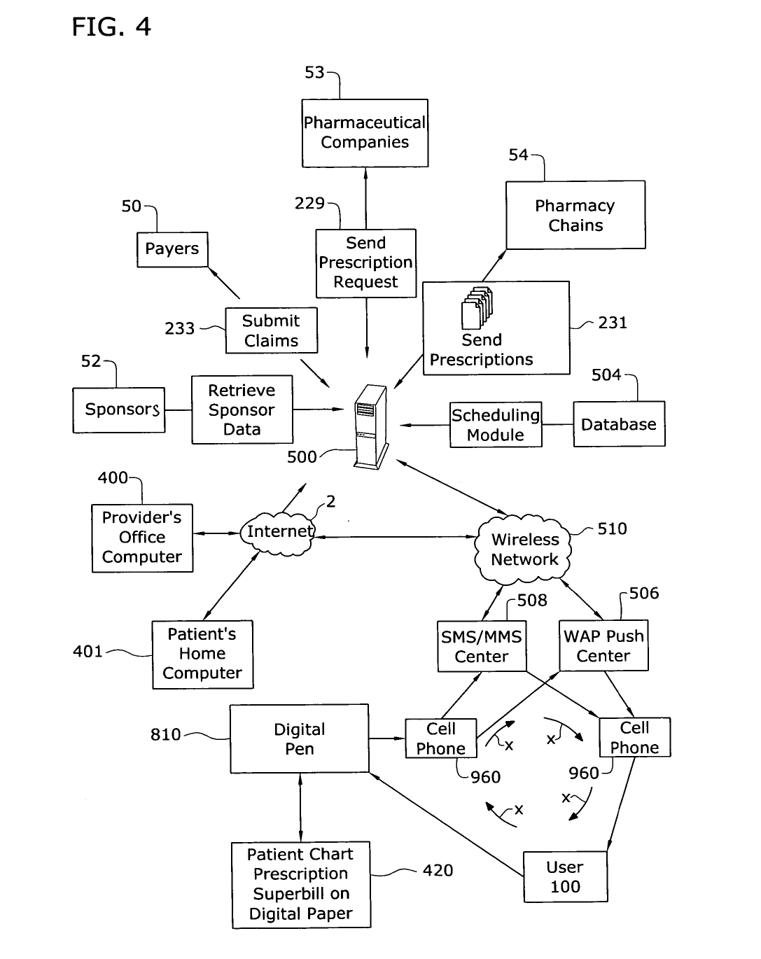

Referring to FIG. 4, server 500 interconnects a mobile healthcare worker to payers 50, sponsors 52, pharmacies 54, pharmaceutical and device companies 53, and even the healthcare workers own computer 400, as well as patient home computer 401. Scheduling data is entered into server 500's scheduling module from computers 400 or 401. To interconnect these workers, payers, patients, and other healthcare entities, server 500 provides a rules-based ASP system, which is accessed via Internet 2, either through land lines or through a wireless wide area network. Although a rules-based system is not required to practice the present invention, one system suitable for use with one embodiment of the present invention is more fully disclosed in U.S. patent application Ser. No. ______ [attorney docket number MDR001]_, filed Aug. 31, 2004, which is hereby incorporated by reference in its entirety.

In accordance with direction arrows X, schedule information in the form of an appointment reminder, along with an encounter slot number, are sent to WAP push center 506 (or alternately GPRS system or other suitable system) and on to healthcare worker user 100's cell phone 960. User 100 creates hardcopy (i.e., patient chart, superbill, and/or prescription 420 on digital paper) and soft copy record with digital pen 810, the latter of which is sent via cell phone 960 to SMS/MMS center 508 (or alternately GPRS system or other suitable system) and on to wireless network 510. Related data are sent to server 500 for interpretation and review. In particular, user 100 writes on pre-printed digital form 420, which includes print out form(s) of a patients chart, prescription and total invoice. Digital pen 810 scans as it writes and coverts optical signal into data that are sent to server 500, which passes data on to connected payers 50, pharmaceutical companies 53, sponsors 52, pharmacies 54, and provider computer 400.

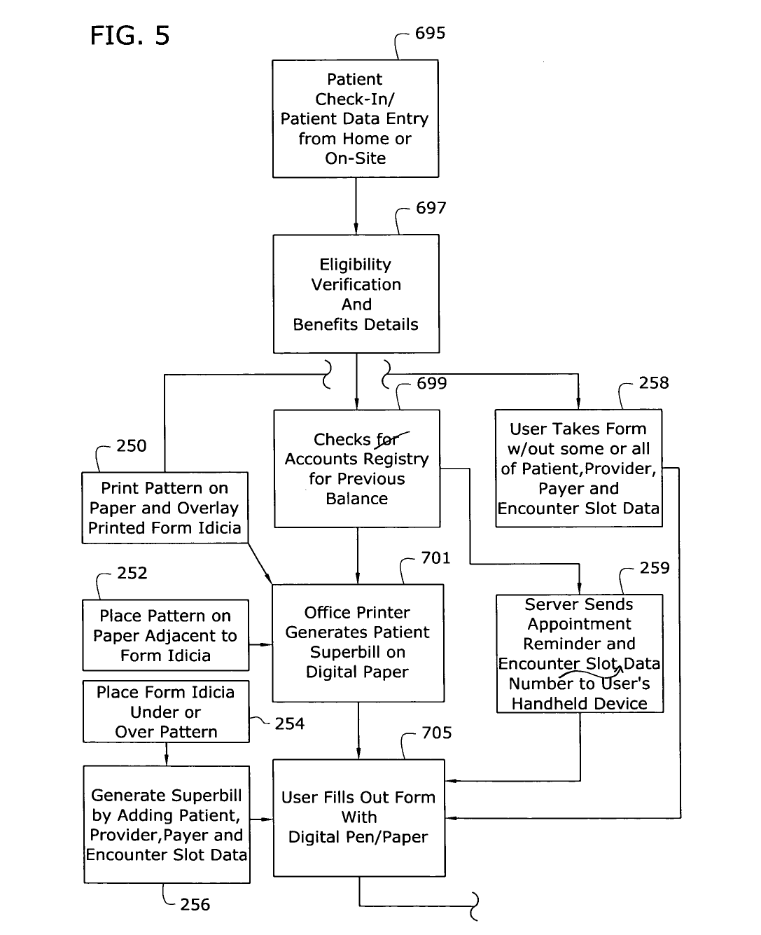

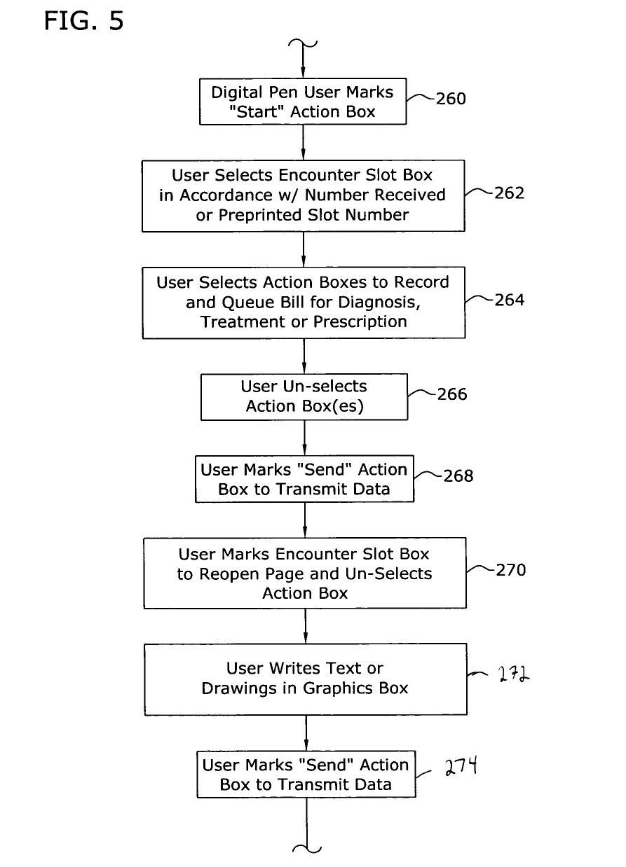

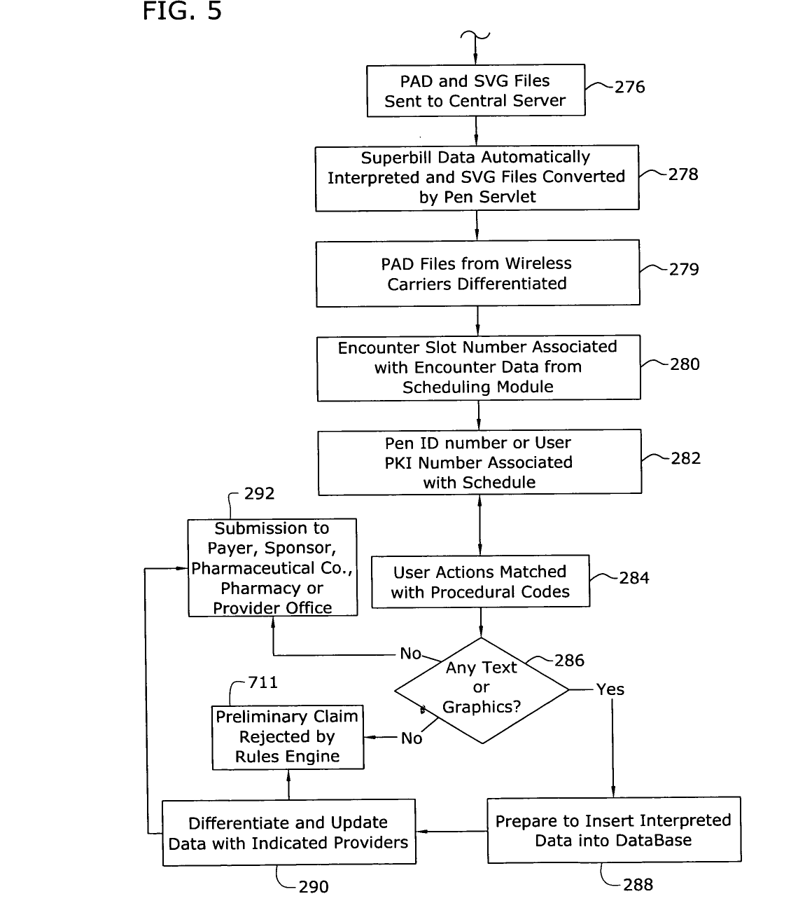

Referring to FIGS. 5, 6 and 7, after check-in 695 and eligibility check 697, which includes retrieval of benefits detail, the account registry is checked 699 for a previous balance by server 500. Patient eligibility status and benefits detail are generated 701 by incorporating these into a soft version of patient chart, prescription and total invoice form, which are stored and printed onto digital paper form or forms 420.

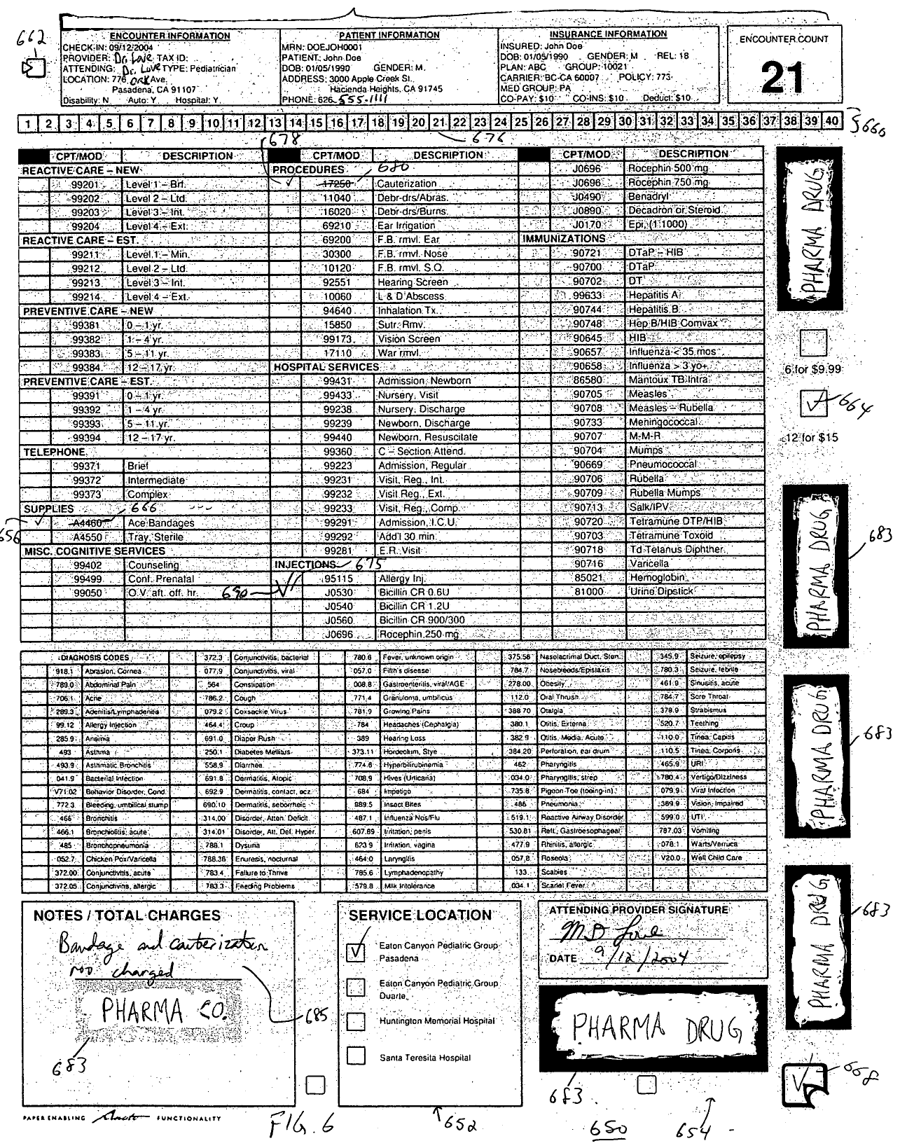

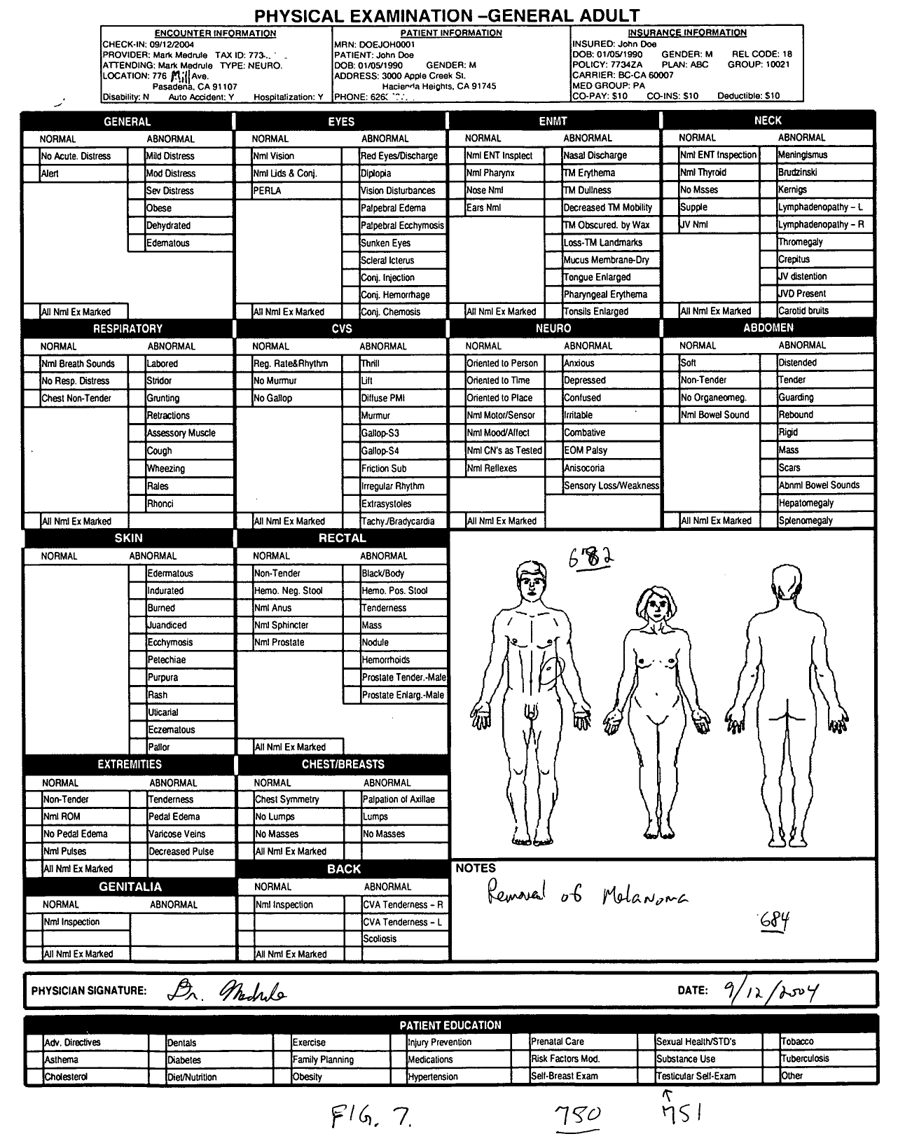

In one embodiment form 420 is created by printing a pattern on smooth laser printer quality paper, which is overlaid by printed form indicia 250. One such pattern can be licensed from Anoto, Inc.® of Sweden. Although such pattern is meaningless to user 100 because it is so small (i.e., about 0.03 mm dot diameter), it can be read by pen 810 as broken into at least two distinct sections. These sections are distinguished by the overlaid printed form indicia, which indicates the distinct sections to the user's eye by showing their pre-designated and individually designed boundaries. These boundaries can be changed and set up on a case-by-case, user-by-user, and even patient-by-patient basis. In fact, any suitable basis can be used to formulate particularized form patterns that are readable by pen 810. Two such form patterns are shown in the backgrounds of forms 650 and 750 respectively shown as patterns 654 and 751 (shown as small dots) in FIGS. 6 and 7.

Form 650 is made by overlaying printed ink indicia 652 that do not absorb, or have very low absorption of 800-950 nm laser light, which is emitted by pen 810 to read black ink background pattern 654 (shown as small dots on most of FIG. 6 page). Pattern 654 can be printed from any type or color of ink, but it must provide contrast with paper on which it is printed to be read by pen 810.

Blue ink user readable indicia 652 make up action boxes, which define various sections of pattern 654. Thus, action boxes are associated with a particular section of pattern 654, which is associated with a particular action. Several exemplary action boxes (and ths actions) include, but are not limited to, identifying/starting an encounter 662, indicating an encounter slot 660, queuing a request to bill for a particular service 656, ordering a product 664, canceling an incorrect billing request 666, and transmitting data to the central server 668, opt in for Direct-to-Consumer (DTC) sales programs. Action box 656, in particular, is associated with recording and queuing an invoice for the administration of ace bandages to the patient in question.

In accordance with scheduling data and user time availability, preliminary encounter information 672 is printed 701 as user readable indicia 652 and the form 650 is given to the user.

Sponsor advertisements 683 are also printed on the form to subsidize the cost of the form or other costs.

In another embodiment, forms are made by placing 252 a pattern on paper adjacent to user readable form indicia. Alternately, user readable form indicia are placed 254 under or over a pattern and a superbill is generated 256 manually (or otherwise according to the particular design of the form) by adding patient, provider, payer, and encounter slot data. For example, a plastic stencil, under which a patterned printed paper sheet is slid, can be used to distinguish pattern sections from one another. Many other paper and non-paper form designs provide suitable embodiments for the present invention. Many combinations and styles of form paper and non-paper forms are suitable for this and other embodiments.

In one embodiment, encounter data is not pre-printed on a form before the patient encounter. Rather, user 100 takes a form that does not have some or all of printed patient, provider, payer or encounter slot number data thereon. Server 100 sends an appointment reminder and encounter slot number data as a SMS to user's phone 960 some time before an appointment.

The user fills out form 650 with pen 810. First, the user marks 260 start action box 662. The user selects 262 encounter slot box 676, in accordance with that number (i.e., “21”) displayed on phone 960 prior to the appointment. The user selects 264 action boxes 656, 675, 678, and 664 respectively to record and bill for application of ace bandage, to record and bill for cauterization procedure, to record and bill for bicillin CR) 0.6 U, and to record and order 12 pharmaceutical company pain killer pills. Check marks are made as appropriate, as seen in FIG. 6. Of course any diagnosis, treatment, or prescription boxes can be used as desired.

If the user decides not to bill or record bandage and so un-selects 266 action box 666. The user then marks 268 send action box 668 with pen 810. Data is send via Bluetooth® radio frequency waves to phone 960, which receives data and automatically sends to the rest of telecommunication wide area wireless network 941 (shown in FIG. 3), of which phone 960 is a part. Phone 960 thereby acts as a transponder.

Transmission action box 668 can be selected at any time, but if over 40 (corresponding to number of encounter slots and associated action boxes 660) encounter data sets are stored with the pen, server 500 sends user 100 a reminder to transmit the stored data by selecting box 668.

If the user thereafter decides to reopen 270 encounter by marking action box 676 again and decides to un-select cauterization recordation and billing by marking action box 680. User explains 272 in writing that cauterization and bandaging were not charged in text action box 685. Correcting pre-empting data are sent 274 to override earlier action commands. Portable application display (PAD) and SVG files are created from action box selections and sent 276 to central server.

Data interpretation is as follows: Super bill data are automatically interpreted and SVG files converted 278 by pen servlet 902 (shown in FIG. 3). In particular, software in central server 500 or an associated server automatically interprets an indicium marking 690, which exists in two or more adjacent sections, as designating a single action, that is recording and billing for administration of bicillin CR 0.6 U. Other user action areas are automatically or manually checked and sent to server 500 administrator for data handling.

Handling data is as follows: PAD files from various carriers are differentiated 279. Encounter slot number “21” data is associated 280 with encounter data from scheduling module in server 500. Unique pen ID number is associated with encounter data 282, and user actions a matched 284 with procedural codes. Because text or graphic markings were made, data in text box of claim is manually reviewed and processed (or automatically by optical character recognition software), and the claim is either rejected and submitted to payer at the end of the day.

In one embodiment, the user does not create an SVG file with text explanation, such that, (1) superbill data is sent 274 and automatically interpreted 278 by pen servlet 902, (2) PAD files from various carriers are differentiated 279, (3) encounter slot number is associated 280 with encounter data from scheduling module in server 500, (4) unique pen ID number is associated with encounter data 282, and (5) user actions a matched 284 with procedural codes. Because no text or graphic marking indicia were made, claim is automatically and immediately processed and either rejected and sent to a provider computer or submitted to a payer and other relevant parties at the end of the day.

After the user fills out form 650, at the end of the day or otherwise in accordance with provider preferences, a pre-processed claim is sent to a payer. If the claim is preliminarily rejected, an e-mail message is sent to the user to request correction 711.

In one embodiment the user's personal key identification (PKI) number is incorporated into pen 810 and matched 282 with encounter data.

In one embodiment, where a prescription is requested pen 810 reduces potential fraud by restricting prescription requests to an attending physician or other healthcare worker.

In anther embodiment, a central server or an associated server automatically corrects an omitted indicium marking where other markings would necessarily require one.

Referring to FIG. 7. in one embodiment, a user may use text action box 682 to note surgical or other procedures such as the “Removal of melanoma” from left abdomen of male patient, as briefly noted in text action box 684.

A second aspect of the invention is directed to a healthcare transaction system. Several of its various embodiments are substantially described above.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments that would come within the spirit and scope of the present invention.

We claim:

1. A healthcare transaction method, comprising:
providing a healthcare worker user access to a remote central server through a user interface, and providing a payer connection to the server or an associated server; and
receiving information from the healthcare worker through the user interface;
wherein the user interface comprises a handheld device that receives data directly from the healthcare worker, and wirelessly transmits it to a wireless telecommunications network that is connected to the remote central server.

2. The method of claim 1 wherein the user interface comprises a radio frequency transmitter that receives manually-input data directly from the healthcare worker, and wirelessly transmits it to a handheld transceiver connected to a wireless network that is connected to the remote central server.

3. The method of claim 2 wherein the transmitter is a pen and the transceiver is a mobile phone.

4. The method of claim 1 wherein the handheld device is a pen that applies marking indicia as it receives data.

5. The method of claim 1 wherein the handheld device receives data by reading a first pattern that has distinct sections.

6. The method of claim 5 wherein the first pattern is optically, magnetically, electrostatically, radioactively, or thermally readable.

7. The method of claim 5 wherein over, under, co-extensive, or adjacent to the pattern is placed user-readable indicia that distinguish to the user, the sections of the first pattern from one another.

8. The method of claim 7 wherein each of the sections is associated with an action.

9. The method of claim 8 wherein the action is identifying an encounter, indicating an encounter slot, queuing a request to bill for a particular service, ordering a product, canceling an incorrect billing request, or transmitting data to the central server.

10. The method of claim 8 wherein previously stored action data is transmitted by marking a section of the pattern.

11. The method of claim 10 wherein the action data is transmitted from a pen to a mobile phone to the central server.

12. The method of claim 8 wherein the pattern and the user readable indicia are printed onto paper that is marked by the user with a marking indicium to initiate the action.

13. The method of claim 7 wherein the pattern is read by a laser light having a range of wavelength.

14. The method of claim 13 wherein the user readable indicia has low absorption of the wavelength range of the laser light.

15. The method of claim 13 wherein the marking indicium has a low absorption of the wavelength range of the laser light.

16. The method of claim 8 wherein an incorrectly selected action is correctable by un-selecting the action.

17. The method of claim 16 wherein un-selecting the action can automatically occur before or after data is transmitted to the central server.

18. The method of claim 16 wherein the action can be selected and un-selected as many times as the user wants.

19. The method of claim 8 wherein the handheld device is a pen that applies marking indicium as it receives data.

20. The method of claim 19 wherein the pen transmits data to a telecommunications-to-server gateway that is in communication with the remote central server.

21. The method of claim 8 wherein the handheld device applies marking indicia to one or more of the sections.

22. The method of claim 21 wherein the central server or an associated server automatically corrects an omitted indicium marking.

23. The method of claim 21 wherein the central server, an associated server, or a person interprets an indicium marking that exists in two or more adjacent sections as designating a single action.

24. The method of claim 23 wherein the indicium marking is a check mark.

25. The method of claim 1 wherein the central server sends the user an appointment reminder.

26. The method of claim 1 wherein the central server sends the user an available encounter slot indication.

27. The method of claim 1 wherein the slot number is used to associate a hardcopy encounter record with a set of encounter data.

28. The method of claim 1 wherein the handheld device records relative positioning data as it is moved by the user.

29. The method of claim 28 wherein the handheld device moves in concert with a surgical instrument.

30. The method of claim 28 wherein the handheld device moves in concert with a writing instrument.

31. A healthcare transaction method, comprising:
providing a healthcare worker access to a remote central server through at least one user interface, and providing at least one payer connection to the server;
receiving information from the healthcare worker through the at least one user interface; and
providing the healthcare worker automated claim handling and claim submission to the at least one payer, based on regularly updated rules;
wherein the at least one user interface comprises a handheld device that receives data directly from the healthcare professional, and wirelessly transmits it to a wireless telecommunications network that is connected to the remote central server.

32. The method of claim 31 wherein the handheld device is a pen that applies marking indicia as it receives data.

33. The method of claim 32 wherein the pen transmits data to a telecommunications-to-server gateway that is in communication with the remote central server.

34. A healthcare transaction system, comprising
a user interface that provides a healthcare worker user access to a remote central server, which receives encounter data from the healthcare worker through the interface; and
an electronic data connection between the central server or an associated server and a payer, through which the server automatically bills the payer;
wherein the user interface comprises a handheld device that receives the encounter data directly from the healthcare worker, and wirelessly transmits it to a wireless telecommunications network that is connected to the remote central server.

35. The system of claim 34 wherein the user interface comprises a radio frequency transmitter that receives manually-input data directly from the healthcare worker, and wirelessly transmits it to a handheld transceiver connected to a wireless network that is connected to the remote central server.

36. The system of claim 35 wherein the transmitter is a pen and the transceiver is a mobile phone.

37. The system of claim 34 wherein the handheld device is a pen that applies marking indicia as it receives data.

38. The system of claim 34 wherein the handheld device receives data by reading a first pattern that has distinct sections.

39. The system of claim 38 wherein the first pattern is optically, magnetically, electrostatically, radioactively, or thermally readable.

40. The system of claim 38 wherein over, under, co-extensive, or adjacent to the pattern is placed user-readable indicia that distinguish to the user, the sections of the first pattern from one another.

41. The system of claim 40 wherein each of the sections is associated with an action.

42. The system of claim 41 wherein the action is identifying an encounter, indicating an encounter slot, queuing a request to bill for a particular service, ordering a product, canceling an incorrect billing request, or transmitting data to the central server.

43. The system of claim 41 wherein previously stored action data is transmitted by marking a section of the pattern.

44. The system of claim 43 wherein the action data is transmitted from a pen to a mobile phone to the central server.

45. The system of claim 41 wherein the pattern and the user readable indicia are printed onto paper that is marked by the user with a marking indicium to initiate the action.

46. The system of claim 40 wherein the pattern is read by a laser light having a range of wavelength.

47. The system of claim 46 wherein the user readable indicia has low absorption of the wavelength range of the laser light.

48. The system of claim 46 wherein the marking indicium has a low absorption of the wavelength range of the laser light.

49. The system of claim 41 wherein an incorrectly selected action is correctable by un-selecting the action.

50. The system of claim 49 wherein un-selecting the action can automatically occur before or after data is transmitted to the central server.

51. The system of claim 49 wherein the action can be selected and un-selected as many times as the user wants.

52. The system of claim 41 wherein the handheld device is a pen that applies marking indicium as it receives data.

53. The system of claim 52 wherein the pen transmits data to a telecommunications-to-server gateway that is in communication with the remote central server.

54. The system of claim 41 wherein the handheld device applies marking indicia to one or more of the sections.

55. The system of claim 54 wherein the central server or an associated server automatically corrects an omitted indicium marking.

56. The system of claim 54 wherein the central server or an associated server automatically interprets an indicium marking that exists in two or more adjacent sections as designating a single action.

57. The system of claim 56 wherein the indicium marking is a check mark.

58. The system of claim 34 wherein the central server sends the user an appointment reminder.

59. The system of claim 34 wherein the central server sends the user an available encounter slot indication.

60. The system of claim 34 wherein the slot number is used to associate a hardcopy encounter record with a set of encounter data.

61. The system of claim 34 wherein the handheld device records relative positioning data as it is moved by the user.

62. The system of claim 61 wherein the handheld device moves in concert with a surgical instrument.

63. The system of claim 61 wherein the handheld device moves in concert with a writing instrument.

64. The system of claim 34 wherein the handheld device simultaneously creates and hard copy and soft copy of the encounter data.

65. The system of claim 64 wherein the hard copy and the soft copy of the data are in the user's personal possession at the time of their creation.

66. A system for automated processing of encounter and billing data while in a roaming environment, comprising:
a static system that creates appointment and encounter slots, and reserves a space for data from a missing patient encounter, and a wireless system that includes, a handheld device that receives and displays reminders and encounter slot number information; and a handheld device that captures and transmits encounter data to the static system, wherein the static system and the wireless system substantially decrease administrative manual transaction data processing.

67. The system of claim 66 wherein the handheld device creates, gathers, stores, and transfers encounter or billing data.

68. The system of claim 66 wherein the static and wireless systems reduces potential fraud by restricting prescription requests to an attending physician or other healthcare worker.
